(19) United States
(12) Patent Application Publication
(10) Pub. No.: US 2012/0151086 A1
(43) Pub. Date: Jun. 14, 2012

(54) System and Method for Content-Oriented Network Interworking

(75) Inventors: Haiyong Xie, Union City, CA (US); Jianming Wu, San Jose, CA (US); Guangyu Shi, Cupertino, CA (US); Guo Qiang Wang, Santa Clara, CA (US)

(73) Assignee: FutureWei Technologies, Inc., Plano, TX (US)

(21) Appl. No.: 13/325,630

(22) Filed: Dec. 14, 2011

Related U.S. Application Data
(60) Provisional application No. 61/422,973, filed on Dec. 14, 2010.

(51) Int. Cl. G06F 15/16

(52) U.S. Cl. 709/232

(57) ABSTRACT

A content-oriented communications network includes an ingress gateway in communication with a legacy client of a first legacy communications network, and an egress gateway in communication with the ingress gateway and a legacy server of a second legacy communications network. The ingress gateway translates a content request of the legacy client from a first legacy protocol to a content-oriented protocol and translates a content reply received in response to the content request from the content-oriented protocol to the first legacy protocol. The egress gateway translates the content request from the content-oriented protocol to a second legacy protocol and translates the content reply received in response to the content request from the second legacy protocol to the content-oriented protocol.

This application claims the benefit of U.S. Provisional Application No. 61/422,973, filed on Dec. 14, 2010, entitled “System and Method for Content-Oriented Network Interworking,” which application is hereby incorporated herein by reference.

### TECHNICAL FIELD

The present invention relates generally to digital communications, and more particularly to a system and method for content-oriented network (CON) interworking.

### BACKGROUND

After 40+ years of journey from its infancy stage to a widely accepted business/application model, the Internet (built upon Transmission Control Protocol/Internet Protocol (TCP/IP)) has become a universal communication platform for user experience and people's daily life. Internet technologies successfully transformed the legacy end-to-end communication from circuit-to-circuit model (i.e., circuit switching) to host-to-host model (i.e., packet switching).

Now there is a fundamental paradigm shift toward a next-generation Internet, namely, transition from connectivity-based networking to content-based networking. The content-based networking is designed and optimized for content itself, not the host-to-host connectivity. The CON will be highly distributed and collaborative to fulfill the need for socialization and personalization.

The next-generation Internet will be transitioning from host-to-host connection model to a trust-to-trust content-oriented networking model. In this new model, the network delivers content and applications based on named data with built-in security, in stead of named hosts. It requires the network to be able to handle more “application semantics” which are relevant to the environmental context of the information such as security/privacy, content name and type, end user device, user location and presence, and content life circle (e.g., time-to-live (TTL)) within the network. In such a CON, content security, content storage, and content delivery are built-in functionalities of the network. It will leverage powerful distributed computing and optimization to minimize capital expenditures (CAPEX) and operational expenditures (OPEX), and to ultimately improve user experience for content.

### SUMMARY OF THE INVENTION

Example embodiments of the present invention which provide a system and method for CON interworking.

In accordance with an example embodiment of the present invention, a content-oriented communications network is provided. The content-oriented network includes an ingress gateway in communication with a legacy client of a first legacy communications network, and an egress gateway in communication with the ingress gateway and a legacy server of a second legacy communications network. The ingress gateway translates a content request of the legacy client from a first legacy protocol to a content-oriented protocol and translates a content reply received in response to the content request from the content-oriented protocol to the first legacy protocol. The egress gateway translates the content request from the content-oriented protocol to a second legacy protocol and translates the content reply received in response to the content request from the second legacy protocol to the content-oriented protocol.

In accordance with another example embodiment of the present invention, a gateway is provided. The gateway includes a receiver, a processor coupled to the receiver, and a transmitter coupled to the processor. The receiver receives a content request from a legacy client of a legacy communications network, the content request in a legacy protocol, and receives a content reply in a content-oriented protocol, the content reply including content requested in the content request. The processor translates the content request from the legacy protocol to the content-oriented protocol, and translates the content reply from the content-oriented protocol to the legacy protocol. The transmitter sends the translated content request to a second gateway, and sends the translated content reply to the legacy client.

In accordance with another example embodiment of the present invention, a gateway is provided. The gateway includes a receiver, a processor coupled to the receiver, and a transmitter coupled to the processor. The receiver receives a content request in a content-oriented protocol from a second gateway, and receives a content reply in a legacy protocol, the content reply including content requested in the content request. The processor translates the content request from the content-oriented protocol to the legacy protocol, and translates the content reply from the legacy protocol to the content-oriented protocol. The transmitter sends the translated content request to a legacy server of a legacy communications system, and sends the translated content reply to the second gateway.

In accordance with another example embodiment of the present invention, a method for operating an ingress gateway of a content-oriented communications network is provided. The method includes receiving a content request from a legacy client of a legacy communications network, the content request in a legacy protocol, and translating the content request from the legacy protocol to a content-oriented protocol. The method also includes sending the translated content request to an egress gateway of the content-oriented communications network, and receiving a content reply in the content-oriented protocol, the content reply including content requested in the content request. The method further includes translating the content reply from the content-oriented protocol to the legacy protocol, and sending the translated content reply to the legacy client.

In accordance with another example embodiment of the present invention, a method for operating an egress gateway of a content-oriented communications network is provided. The method includes receiving a content request in a content-oriented protocol from an ingress gateway, and translating the content request from the content-oriented protocol to a legacy protocol. The method also includes sending the translated content request to a legacy server of a legacy communications network, and receiving a content reply in the legacy protocol, the content reply including content requested in the content request. The method further includes translating the content reply from the legacy protocol to the content-oriented protocol, and sending the translated content reply to the ingress gateway.

An advantage of an embodiment is that no modifications to legacy clients or legacy servers are required.

Yet another advantage of an embodiment is that control plane and data plane application programming interfaces (APIs) are separated.

Still another advantage of an embodiment is that content and requests may be segmented, serialized, and aggregated to improve efficiency.

A further advantage of an embodiment is that the separation of the logical entity and the physical entity allows for flexible implementation and placement.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates an example legacy communications system;

FIG. 2 illustrates an example communications system, wherein a Content-Oriented Network Architecture (CONA) network co-exists with legacy clients and legacy servers according to example embodiments described herein;

FIG. 3a illustrates an example communications system wherein a CONA network interoperates with legacy clients and legacy servers, wherein the CONA network includes a proactive ICG and a lightweight ECG according to example embodiments described herein;

FIG. 3b illustrates an example flow diagram of operations occurring in a communications system that supports legacy clients and legacy servers but utilizes CONA protocols according to example embodiments described herein;

FIG. 3c illustrates an example flow diagram of operations occurring in an ICG of a communications system that supports legacy clients and legacy servers but utilizes CONA protocols, wherein the ICG is a proactive ICG according to example embodiments described herein;

FIG. 3d illustrates an example flow diagram of operations occurring in a network entity of a communications system that supports legacy clients and legacy servers but utilizes CONA protocols according to example embodiments described herein;

FIG. 3e illustrates an example flow diagram of operations occurring in an ECG of a communications system that supports legacy clients and legacy servers but utilizes CONA protocols, wherein the ECG is a lightweight ECG according to example embodiments described herein;

FIG. 4a illustrates an example diagram of a communications system wherein a CONA network interoperates with legacy clients utilizing a previous version of a CONA protocol and legacy servers according to example embodiments described herein;

FIG. 4b illustrates an example diagram of a communications system wherein a CONA network interoperates with legacy clients and legacy servers utilizing a previous version of a CONA protocol according to example embodiments described herein;

FIG. 4c illustrates an example diagram of a communications system wherein a CONA network interoperates with legacy clients utilizing a previous version of a CONA protocol and legacy servers utilizing a previous version of a CONA protocol according to example embodiments described herein;

FIG. 5a illustrates an example diagram of a communications system wherein a CONA network interoperates with legacy clients and legacy servers, wherein the CONA network includes a lightweight ICG and an intelligent ECG according to example embodiments described herein;

FIG. 5b illustrates an example flow diagram of operations occurring in a communications system that supports legacy clients and legacy servers but utilizes CONA protocols according to example embodiments described herein;

FIG. 5c illustrates an example flow diagram of operations occurring in an ICG of a communications system that supports legacy clients and legacy servers but utilizes CONA protocols, wherein the ICG is a lightweight ICG according to example embodiments described herein;

FIG. 5d illustrates an example flow diagram of operations occurring in a network entity of a communications system that supports legacy clients and legacy servers but utilizes CONA protocols according to example embodiments described herein;

FIG. 5e illustrates an example flow diagram of operations occurring in an ECG of a communications system that supports legacy clients and legacy servers but utilizes CONA protocols, wherein the ECG is an intelligent ECG according to example embodiments described herein;

FIG. 6a illustrates an example diagram of a communications system wherein a CONA network interoperates with legacy clients and legacy servers, wherein the CONA network includes an ICG and an ECG that are connected by a tunnel according to example embodiments described herein;

FIG. 6b illustrates an example flow diagram of operations occurring in a communications system that supports legacy clients and legacy servers but utilizes CONA protocols according to example embodiments described herein;

FIG. 6c illustrates an example flow diagram of operations occurring in an ICG of a communications system that supports legacy clients and legacy servers but utilizes CONA protocols according to example embodiments described herein;

FIG. 6d illustrates an example flow diagram of operations occurring in a network entity of a communications system that supports legacy clients and legacy servers but utilizes CONA protocols according to example embodiments described herein;

FIG. 6e illustrates an example flow diagram of operations occurring in an ECG of a communications system that supports legacy clients and legacy servers but utilizes CONA protocols according to example embodiments described herein; and

FIG. 7 illustrates an example diagram of a communications device according to example embodiments described herein.

### DETAILED DESCRIPTION OF ILLUSTRATIVE EMBODIMENTS

The operating of the current example embodiments and the structure thereof are discussed in detail below. It should be appreciated, however, that the present invention provides many applicable inventive concepts that can be embodied in a wide variety of specific contexts. The specific embodiments discussed are merely illustrative of specific structures of the invention and ways to operate the invention, and do not limit the scope of the invention.

One embodiment of the invention relates to content oriented networks interoperating with legacy networks. For example, an ingress gateway serves as an interface for a CONA network and legacy clients, providing protocol translation between the CONA protocol and a legacy protocol used by the legacy clients, while an egress gateway serves as an interface for the CONA network and legacy servers, providing protocol translation between the CONA protocol and a legacy protocol used by the legacy servers. A combination of ingress gateway, egress gateway, and CONA network also provides segmentation, serialization, meta data manipulation, as well as content caching. It is noted that legacy clients and legacy servers may also be applicable to clients and servers compatible with earlier versions of CONA protocols, while legacy protocols may be an earlier version of a CONA protocol.

The present invention will be described with respect to preferred embodiments in a specific context, namely an interworking with a Content-Oriented Network Architecture (CONA) network and legacy network clients and servers.

CONA is a new-generation platform for content-centric networking model. CONA is a cutting-edge technology to deliver contents by leveraging and consolidating the advanced distributed computing, joint optimization based routing/forwarding protocols, and more cross/inter-layer optimization algorithms. CONA is aimed at providing content/application delivery services with these enabling technologies to create a “green” and “behavior-adaptable” environment for people sharing information globally. CONA-enabled networks are targeting to seamlessly bridge and process multiple types of resource semantics and logics, including personalized/socialized user groups, ubiquitous content, and infrastructure network resources.

However, it is most likely that CONA networks will co-exist with legacy networks for a long time and gradually replaces the latter. Legacy network is a term that is commonly used to describe a network that is compatible with older communications protocols including previous versions of current protocols. As an example, legacy networks may include IP networks, as well as CONA networks based on previous versions of CONA protocols. Legacy networks may also be referred to as traditional networks.

During the co-existence, it is inevitable that CONA network instances (i.e., CONA network clouds) interoperate with the legacy networks (e.g., fetch content from legacy networks and distribute it to legacy clients). There are many ways of allowing CONA to work in co-existence with legacy networks. However, all of them require the concept of CONA Gateway, which acts as an interfacing equipment to bridge CONA and legacy networks.

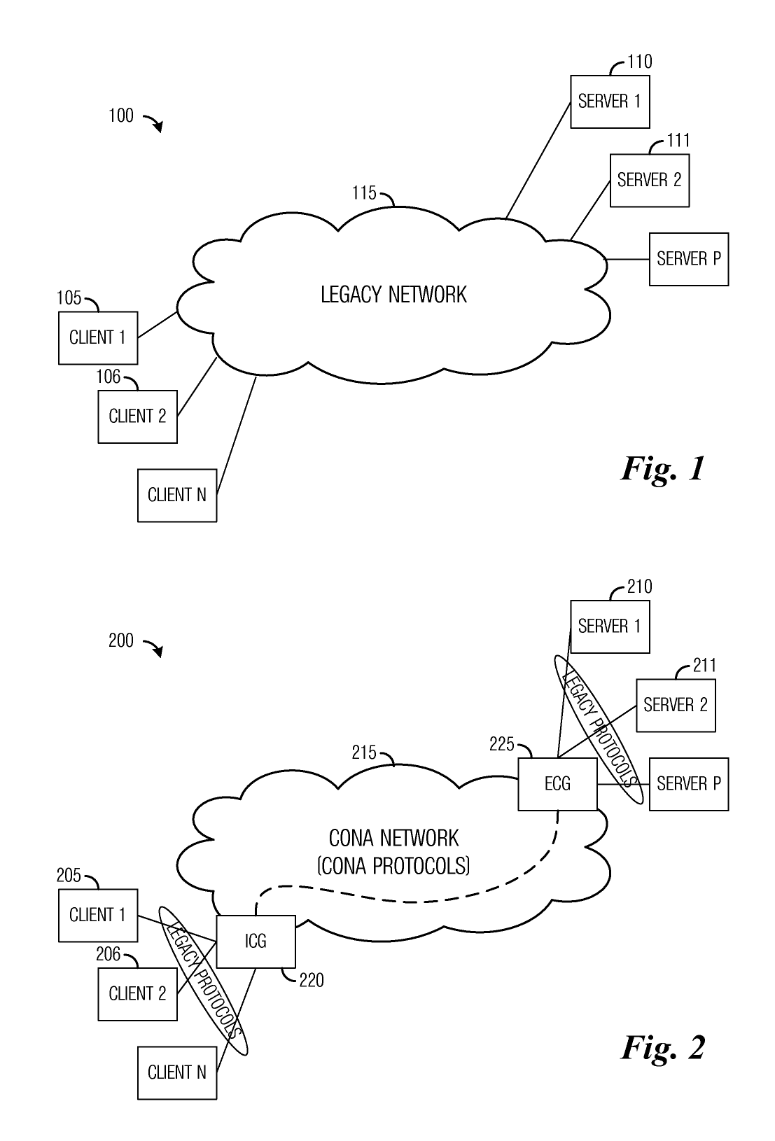

FIG. 1 illustrates a legacy communications system 100. Communications system 100 is a legacy network, such as a point-to-point network (for example, the Internet) or a CONA network based on a previous version of a CONA protocol. Communications system 100 includes a number of clients (such as client 1 105, client 2 106, and so on) and a number of servers (such as server 1 110, server 2 111, and so forth). Communications between a client and a server may occur over a legacy network 115. As an example, information being shared between client 1 105 and server 2 111 may be exchanged between the two in the form of data packets.

Although CONA networks may be the preferred communications system architecture for new communications systems, due to deployment expenses and large investments in existing infrastructure, it is unlikely that CONA networks will replace legacy communications systems overnight. Therefore, CONA networks may gradually replace legacy communications systems. As an example, a CONA network may be deployed as an overlay of a legacy communications system and the CONA network may gradually replace the legacy communications system. Hence, there is a need to provide support for legacy clients and legacy servers until they are replaced by CONA compliant clients and servers.

According to an example embodiment, concepts of CONA networks include:

Content Profile—Meta data for content (e.g., content identifier, number of segments, locations where each segment is available, origin (i.e., legacy servers storing the content), and the like); and Policy data for content (e.g., content publisher's publishing policies for caching and consumption of the content).

Content Retrieval—Segmentation: any content is split into multiple segments with pre-defined sizes; Request for content is split into multiple smaller requests with one request per segment; and Requests and responses are encoded in a CONA protocol.

Name Resolution (NR)—Given a content identifier, resolve it to the location(s) where it is available.

Content Caching and Update—Any CONA network element may decide to locally cache any content segment (based on content policy); When segments are cached locally at a CONA network element, the latter needs to update the content profile; Content profile is stored and synchronized in a rendezvous point (a logically centralized but physically distributed infrastructure, for example).

FIG. 2 illustrates a communications system 200. Communications system 200 is an interworking of legacy clients (such as client 1 205, client 2 206, and so on), legacy servers (such as server 1 210, server 2 211, and so forth), and a CONA network 215. Since the legacy clients and the legacy servers are generally not compatible with CONA network 215, devices may be needed to serve as interfaces between communications protocols used by the legacy clients and the legacy servers and CONA network 215.

As an example, devices may be used to translate between legacy protocols and CONA protocols. According to an example embodiment, a CONA protocol may be a communications protocol designed to operate with content objects, such as object naming, object locating, object routing, object delivery, object dissemination, object caching, object publishing, object subscription, object accounting, object billing, and the like.

In order to provide interoperability with the legacy clients and the legacy servers, example CONA network may accomplish the following tasks:

(1) CONTENT META DATA—content meta data maintenance including content size probing (CSP), content type probing (CTP), content meta data (CMD), and profile creation (CPC);

(2) SEGMENTATION—content segmentation and serialization (CSG);

(3) PROTOCOL TRANSLATION—CONA/legacy protocol translation including content request serialization (CRS) involving legacy protocol to CONA protocol, content retrieval from legacy server (CRO) involving CONA protocol to and from legacy protocol, and content data serialization (CDS) involving CONA protocol to legacy protocol; and

(4) CONA INTERNAL CACHING—CONA internal processing: segment/profile update (CSPU), and segment-based caching (SBC).

As used herein, segmentation may be descriptive of the splitting of a monolithic legacy request into multiple CONA segment requests and serialization may be descriptive of the assembling of CONA segment requests into legacy requests (either complete or incomplete).

A CONA network co-exists with the legacy communications system (and the legacy clients and the legacy servers) and may provide the above listed tasks somewhere within the CONA network. A CONA gateway may be utilized to provide interoperability between the CONA network and the legacy communications system without disrupting and/or modifying the legacy communications system.

According to an embodiment, there may be two different types of CONA gateways: an ingress CONA gateway (ICG) may directly face the legacy clients (as an example, ICG 220 may face the legacy clients), while an egress CONA gateway (ECG) may directly face the legacy servers (as an example, ECG 225 may face the legacy servers). An ICG translates legacy protocols to CONA protocols and an ECG translates CONA protocols to legacy protocols. The ICG and the ECG may be logical entities, meaning that they may be combined into one or more physical network elements.

The ICG and the ECG may jointly implement the above listed tasks, forming a closed boundary for the CONA network to communicate with legacy communications system, and implementing communications protocol translation functionalities so that the legacy communications system do not need to be modified, thereby easing deployment scenarios.

As discussed above, the ICG and the ECG may implement the above listed tasks; however, according to example embodiments, there may be a minimum set of functions performed by the ICG and the ECG. For PROTOCOL TRANSLATION: Both the ICG and the ECG perform protocol translation; SEGMENTATION: Both the ICG and the ECG perform segmentation; SERIALIZATION: Both the ICG and the ECG perform serialization; CONTENT META DATA: Both the ICG and the ECG perform content meta data manipulation; and CONTENT CACHING: Content caching is optional for the ICG and/or the ECG.

Although the ICG and the ECG are shown as distinct entities, they may be implemented as a single network entity. According to an embodiment, a single network entity may implement all of the tasks discussed previously. According to an alternative embodiment, multiple network entity may implement all of the tasks discussed previously with each network entity implementing one or more of the tasks. According to yet another alternative embodiment, a separate network entity may implement one of the tasks discussed previously.

According to yet another alternative embodiment, the ICG and/or the ECG (or some of the ICG and/or the ECG functionality) may be implemented in one or more of the legacy clients and/or the legacy servers.

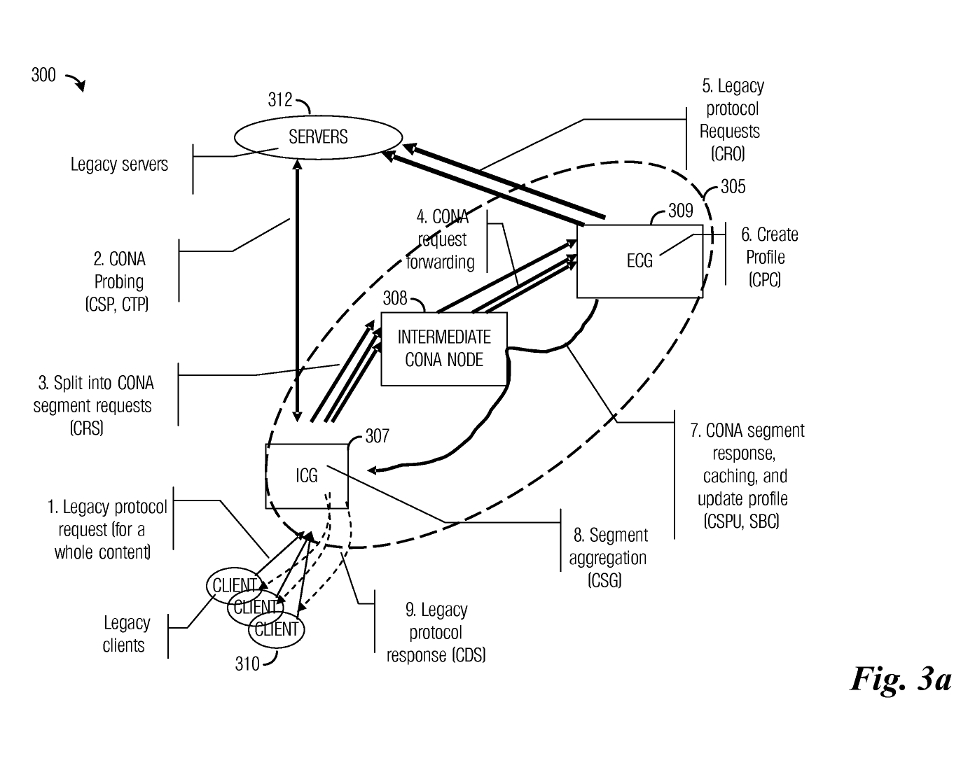

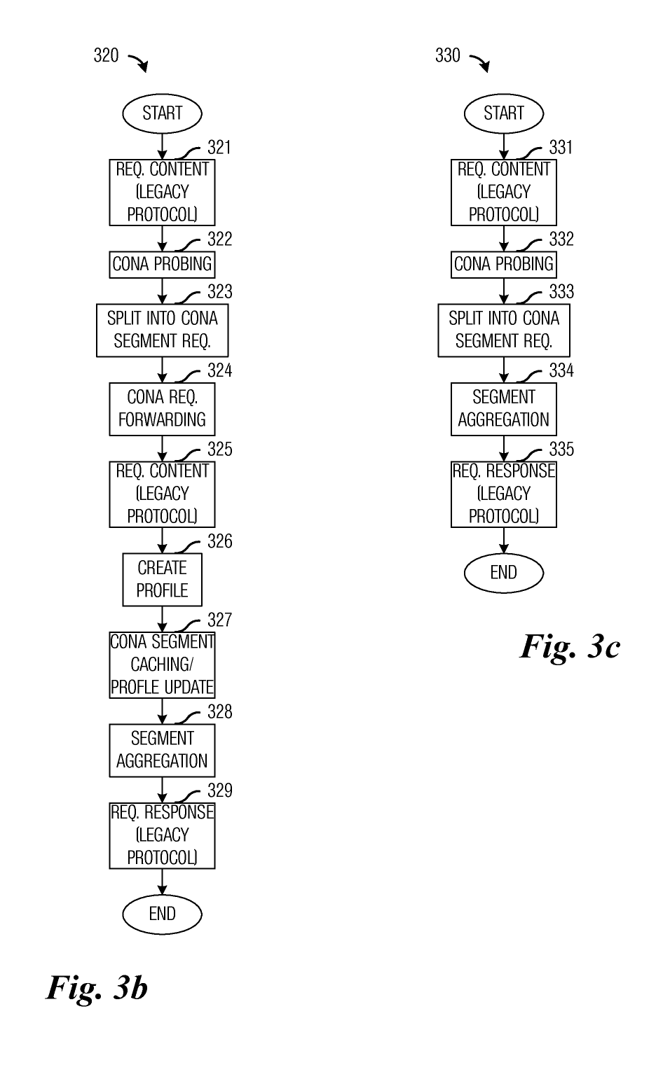

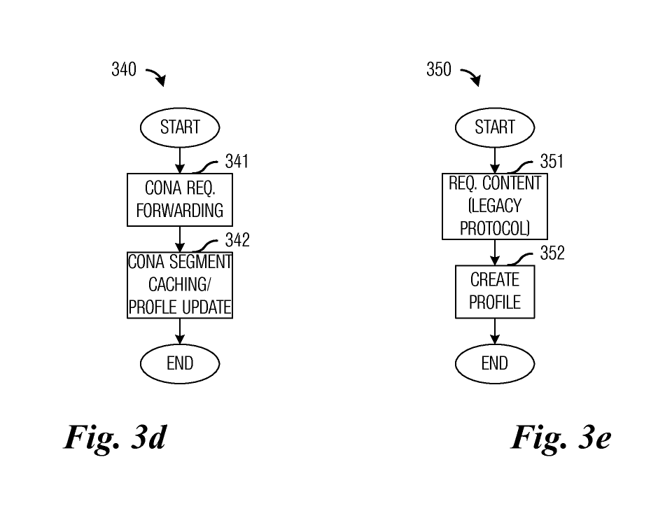

FIG. 3a illustrates a communications system 300 wherein a CONA network 305 interoperates with legacy clients 310 and legacy servers 312, wherein CONA network 305 includes a proactive ICG 307, an intermediate CONA node 308, and a lightweight ECG 309. Intermediate CONA node 308 may also be referred to as a content-oriented network entity. It is noted that although intermediate CONA node 308 is shown in FIG. 3a as being a separate entity from ICG 307 and ECG 309, in some example embodiments, intermediate CONA node 308 may be co-located with or a part of ICG 307 or ECG 309, or intermediate CONA node 308 may be co-located with or a part of ICG 307 and ECG 309.

As shown in FIG. 3a, proactive ICG 307 may be responsible for performing the following tasks: Content meta data (CSP and CTP), CONA/Legacy protocol translation (CRS and CDS), and Segmentation and Serialization (CSG), while the lightweight ECG 309 may be responsible for performing the following tasks: Content meta data (CPC), and CONA/Legacy protocol translation (CRO). CONA network 305 (or an entity in CONA network 305, such as intermediate CONA node 308) may perform CONA internal caching (CSPU and SBC). The above listed tasks for proactive ICG 307 and lightweight ECG 309 are for illustrative purposes and are not intended to be limiting to the scope or the spirit of the example embodiments.

FIG. 3b illustrates a flow diagram of operations 320 occurring in a communications system that supports legacy clients and legacy servers but utilizes CONA protocols.

Operations 320 may begin with an ICG receiving a legacy protocol request for content from a legacy client (i.e., a content request), wherein the legacy protocol request may be a request for the content in its entirety (block 321). The ICG may then perform probing of legacy servers (block 322). According to an embodiment, the probing of the legacy servers may utilize CONA protocols and involve CSP and/or CTP. The ICG may also split the legacy protocol request into multiple CONA protocol segment requests (CRS) (block 323).

A CONA network entity may perform CONA protocol request forwarding to an ECG (block 324). The ECG may perform protocol translation and send the CONA protocol segment requests to the legacy server (CRO) (block 325). The ECG may also create a profile for the content (CPC) (block 326). A CONA network entity, such as intermediate CONA node 308, may perform tasks such as CONA segment response, segment caching, and profile updating (CSPU and/or SBC) (block 327). The ICG may perform segment aggregation (CSG) (block 328) and protocol translation and send legacy protocol response(s) (i.e., a content reply(s)) to the legacy client (CDS) (block 329).

FIG. 3c illustrates a flow diagram of operations 330 occurring in an ICG of a communications system that supports legacy clients and legacy servers but utilizes CONA protocols, wherein the ICG is a proactive ICG.

Operations 330 may begin with an ICG receiving a legacy protocol request for content from a legacy client (i.e., a content request), wherein the legacy protocol request may be a request for the content in its entirety (block 331). The ICG may then perform probing of legacy servers (block 332). According to an embodiment, the probing of the legacy servers may utilize CONA protocols and involve CSP and/or CTP. The ICG may also split the legacy protocol request into multiple CONA protocol segment requests (CRS) (block 333). The ICG may perform segment aggregation (CSG) (block 334) and protocol translation and send legacy protocol response(s) to the legacy client (CDS) (block 335).

FIG. 3d illustrates a flow diagram of operations 340 occurring in a network entity of a communications system that supports legacy clients and legacy servers but utilizes CONA protocols.

Operations 340 may begin with a CONA network entity may perform CONA protocol request forwarding to an ECG (block 341). A CONA network entity may perform tasks such as CONA segment response, segment caching, and profile updating (CSPU and/or SBC) (block 342).

FIG. 3e illustrates a flow diagram of operations 350 occurring in an ECG of a communications system that supports legacy clients and legacy servers but utilizes CONA protocols, wherein the ECG is a lightweight ECG.

Operations 350 may begin with the ECG performing protocol translation and sending the CONA protocol segment requests to the legacy server (CRO) (block 351). The ECG may also create a profile for the content (CPC) (block 352).

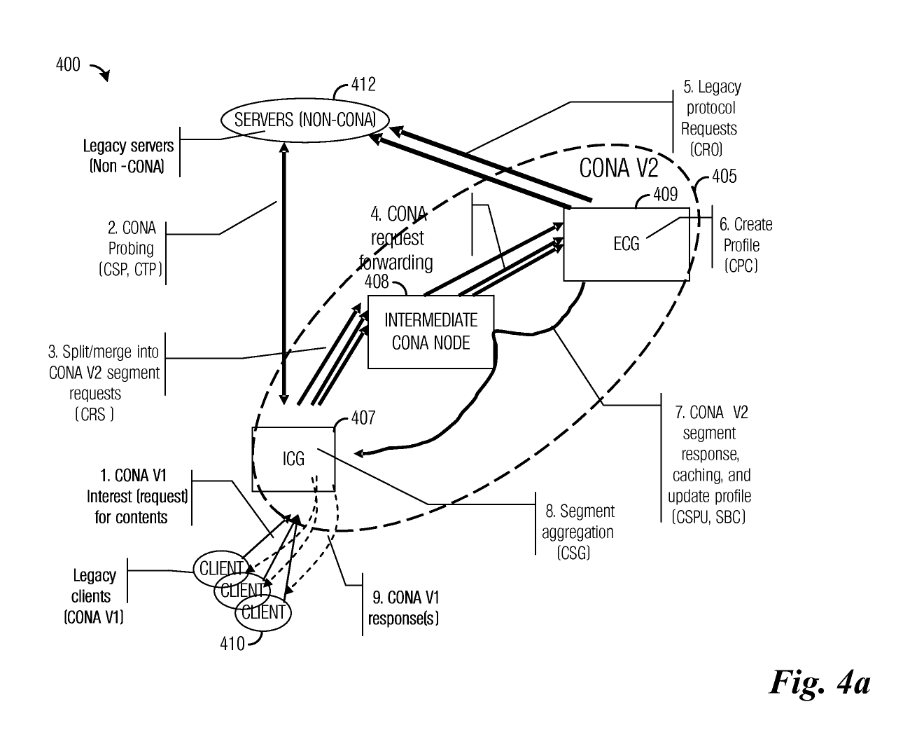

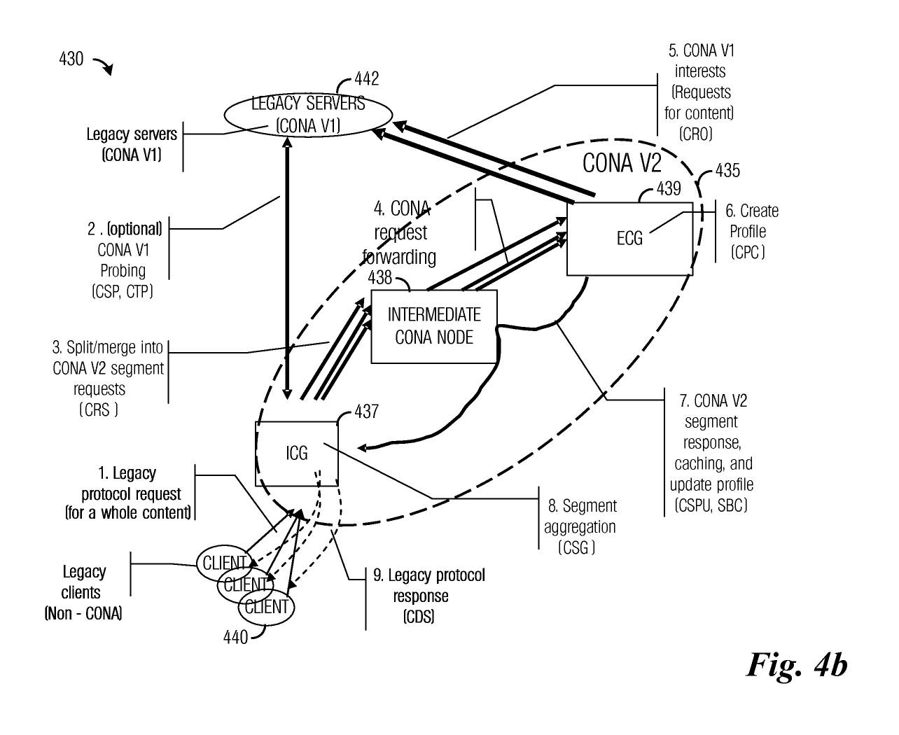

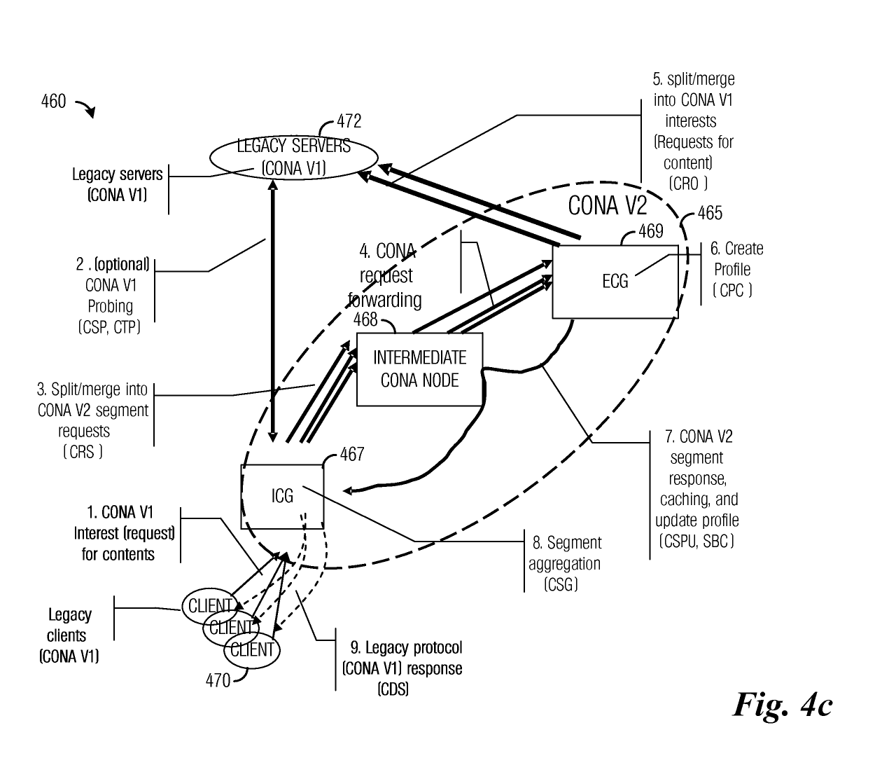

FIG. 4a illustrates a communications system 400 wherein a CONA network 405 that operates using a CONA Version 2 protocol (CONA V2) and interoperates with legacy clients 410 that utilize a CONA Version 1 protocol (CONA V1) and legacy servers 412 at utilize a non-CONA protocol, wherein CONA network 405 includes a proactive ICG 407, an intermediate CONA node 408, and a lightweight ECG 409. Intermediate CONA node 408 may also be referred to as a content-oriented network entity. It is noted that although intermediate CONA node 408 is shown in FIG. 4a as being a separate entity from ICG 407 and ECG 409, in some example embodiments, intermediate CONA node 408 may be co-located with or a part of ICG 407 or ECG 409, or intermediate CONA node 408 may be co-located with or a part of ICG 407 and ECG 409.

As shown in FIG. 4a, proactive ICG 407 may be responsible for performing the following tasks: Content meta data (CSP and CTP), CONA/Legacy protocol translation (CRS and CDS), and Segmentation and Serialization (CSG), while the lightweight ECG 409 may be responsible for performing the following tasks: Content meta data (CPC), and CONA/Legacy protocol translation (CRO). CONA network 405 (or an entity in CONA network 405, such as intermediate CONA node 408) may perform CONA internal caching (CSPU and SBC). The above listed tasks for proactive ICG 407 and lightweight ECG 409 are for illustrative purposes and are not intended to be limiting to the scope or the spirit of the example embodiments.

FIG. 4b illustrates a communications system 430 wherein a CONA network 435 that operates using a CONA Version 2 protocol (CONA V2) and interoperates with legacy clients 440 that utilize a non-CONA protocol and legacy servers 442 at utilize a CONA VI protocol, wherein CONA network 435 includes a proactive ICG 437, an intermediate CONA mode 438, and a lightweight ECG 439. Intermediate CONA node 408 may also be referred to as a content-oriented network entity. It is noted that although intermediate CONA node 438 is shown in FIG. 4b as being a separate entity from ICG 437 and ECG 439, in some example embodiments, intermediate CONA node 438 may be co-located with or a part of ICG 437 or ECG 439, or intermediate CONA node 438 may be co-located with or a part of ICG 437 and ECG 439.

As shown in FIG. 4b, proactive ICG 437 may be responsible for performing the following tasks: Content meta data (CSP and CTP), CONA/Legacy protocol translation (CRS and CDS), and Segmentation and Serialization (CSG), while the lightweight ECG 439 may be responsible for performing the following tasks: Content meta data (CPC), and CONA/Legacy protocol translation (CRO). CONA network 435 (or an entity in CONA network 435, such as intermediate CONA node 438) may perform CONA internal caching (CSPU and SBC). The above listed tasks for proactive ICG 437 and lightweight ECG 439 are for illustrative purposes and are not intended to be limiting to the scope or the spirit of the example embodiments.

FIG. 4c illustrates a communications system 460 wherein a CONA network 465 that operates using a CONA Version 2 protocol (CONA V2) and interoperates with legacy clients 470 that utilize a CONA VI protocol and legacy servers 472 at utilize a CONA VI protocol, wherein CONA network 465 includes a proactive ICG 467, an intermediate CONA node 468, and a lightweight ECG 469. Intermediate CONA node 468 may also be referred to as a content-oriented network entity. It is noted that although intermediate CONA node 468 is shown in FIG. 4c as being a separate entity from ICG 467 and ECG 469, in some example embodiments, intermediate CONA node 468 may be co-located with or a part of ICG 467 or ECG 469, or intermediate CONA node 468 may be co-located with or a part of ICG 467 and ECG 469.

Although legacy clients 470 and legacy servers 472 are shown as utilizing the same CONA protocol (i.e., CONA V1 protocol), legacy clients 470 and legacy servers 472 may utilize different versions of CONA protocols. As shown in FIG. 4c, proactive ICG 467 may be responsible for performing the following tasks: Content meta data (CSP and CTP), CONA/Legacy protocol translation (CRS and CDS), and Segmentation and Serialization (CSG), while the lightweight ECG 469 may be responsible for performing the following tasks: Content meta data (CPC), and CONA/Legacy protocol translation (CRO). CONA network 465 (or an entity in CONA network 465, such as intermediate CONA node 468) may perform CONA internal caching (CSPU and SBC). The above listed tasks for proactive ICG 467 and lightweight ECG 469 are for illustrative purposes and are not intended to be limiting to the scope or the spirit of the example embodiments.

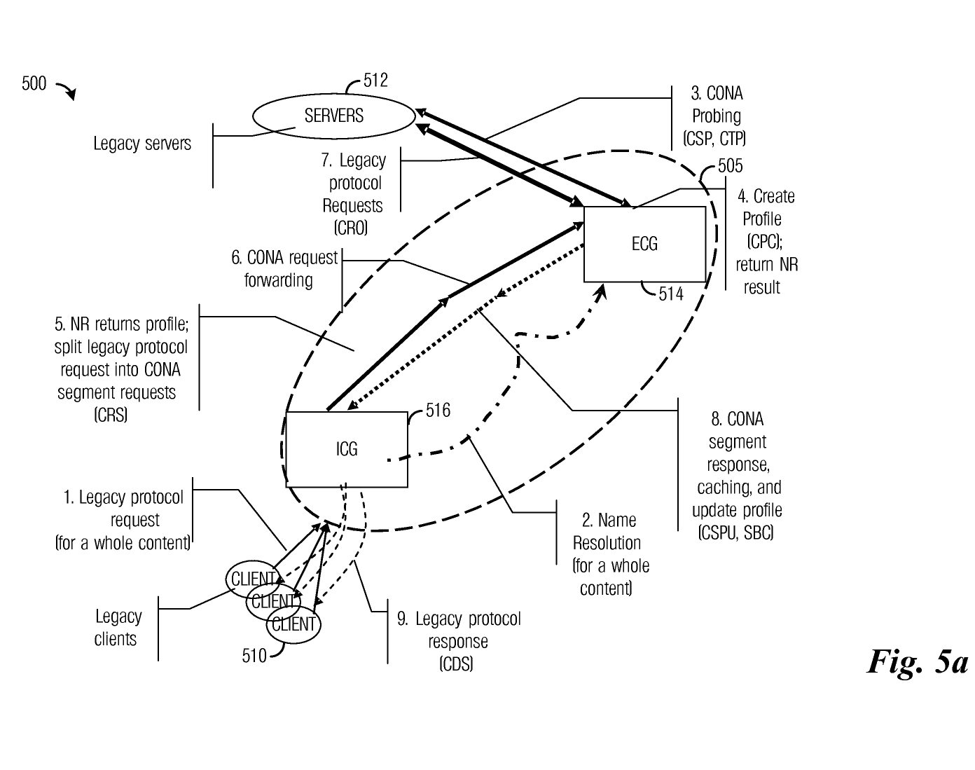

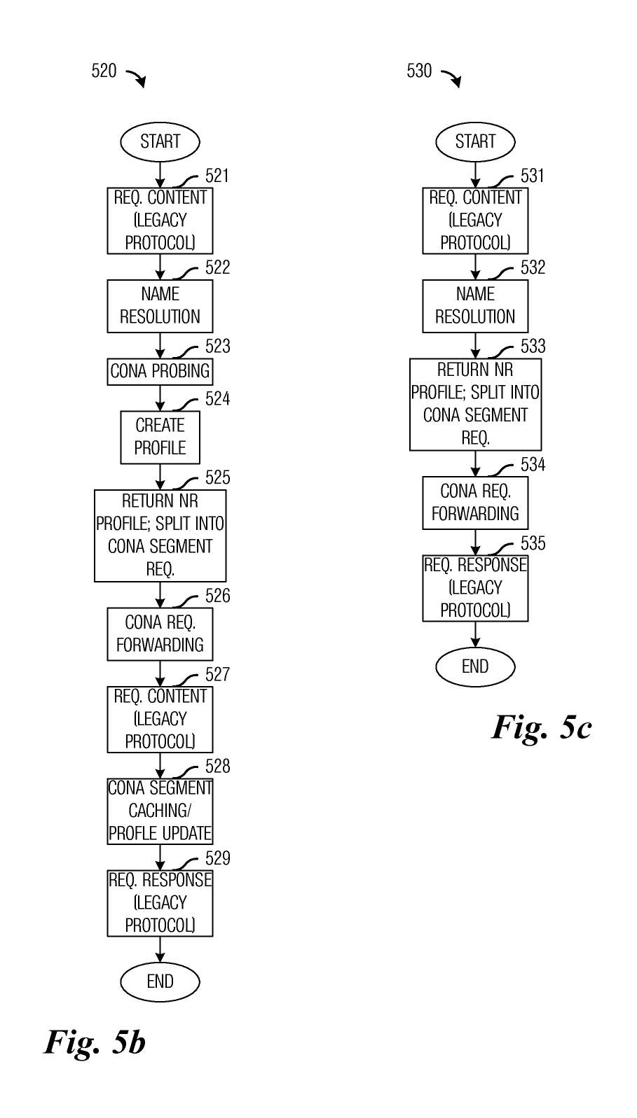

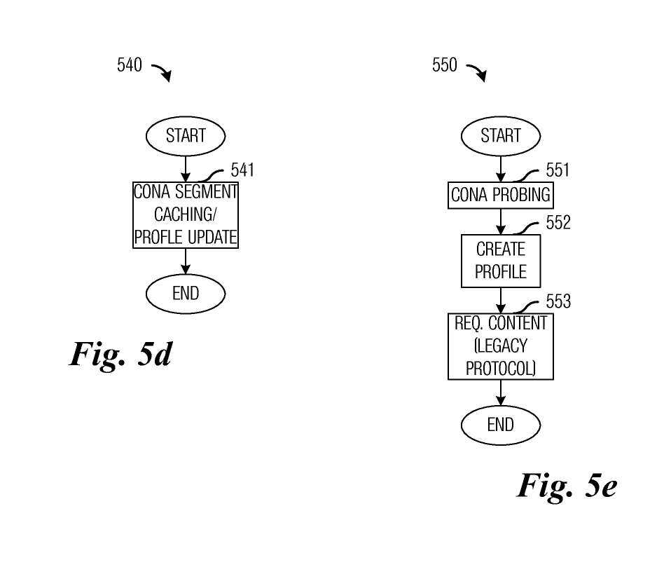

FIG. 5a illustrates a communications system 500 wherein a CONA network 505 interoperates with legacy clients 510 and legacy servers 512, wherein CONA network 505 includes a lightweight ICG 516 and an intelligent ECG 514. As shown in FIG. 5a, lightweight ICG 516 may be responsible for performing the following tasks: CONA/Legacy protocol translation (CRS and CDS), while the intelligent ECG 514 may be responsible for performing the following tasks: Content meta data (CSP, CTP, and CPC), Segmentation (CSG), and CONA/Legacy protocol translation (CRO). CONA network 505 (or an entity in CONA network 505) may perform CONA internal caching (CSPU and SBC). The above listed tasks for proactive ICG 516 and intelligent ECG 514 are for illustrative purposes and are not intended to be limiting to the scope or the spirit of the example embodiments.

FIG. 5b illustrates a flow diagram of operations 520 occurring in a communications system that supports legacy clients and legacy servers but utilizes CONA protocols.

Operations 520 may begin with an ICG receiving a legacy protocol request for content from a legacy client (i.e., a content request), wherein the legacy protocol request may be a request for the content in its entirety (block 521). The ICG may perform name resolution for the whole content (block 522). An ECG may perform probing of legacy servers (block 523). According to an embodiment, the probing of the legacy servers may utilize CONA protocols and involve CSP and/or CTP. The ECG may also create a profile for the content (CPC) as well as return the name resolution result (block 524).

The ICG may return the name resolution result, split the legacy protocol request into CONA segment requests (CRS) (block 525), as well as CONA request forwarding to the ECG (block 526). The ECG may perform protocol translation and forward the legacy protocol requests to the legacy server (CRO) (block 527). A CONA network entity may forward the CONA segment response in addition to segment caching and profile updating (CSPU and SBC) (block 528). The ICG may send the legacy protocol response (i.e., a content reply) to the legacy client (CDS) (block 529).

FIG. 5c illustrates a flow diagram of operations 530 occurring in an ICG of a communications system that supports legacy clients and legacy servers but utilizes CONA protocols, wherein the ICG is a lightweight ICG.

Operations 530 may begin with an ICG receiving a legacy protocol request for content from a legacy client, wherein the legacy protocol request may be a request for the content in its entirety (block 531). The ICG may perform name resolution for the whole content (block 532). An ECG may perform probing of legacy servers. According to an embodiment, the probing of the legacy servers may utilize CONA protocols and involve CSP and/or CTP. The ECG may also create a profile for the content (CPC) as well as return the name resolution result.

The ICG may return the name resolution result, split the legacy protocol request into CONA segment requests (CRS) (block 533), as well as CONA request forwarding to the ECG (block 534). The ICG may send the legacy protocol response to the legacy client (CDS) (block 535).

FIG. 5d illustrates a flow diagram of operations 540 occurring in a network entity of a communications system that supports legacy clients and legacy servers but utilizes CONA protocols.

Operations 540 may begin with a CONA network entity forwarding the CONA segment response in addition to segment caching and profile updating (CSPU and SBC) (block 541).

FIG. 5e illustrates a flow diagram of operations 550 occurring in an ECG of a communications system that supports legacy clients and legacy servers but utilizes CONA protocols, wherein the ECG is an intelligent ECG.

Operations 550 may begin with the ECG performing a probing of legacy servers (block 551). According to an embodiment, the probing of the legacy servers may utilize CONA protocols and involve CSP and/or CTP. The ECG may also create a profile for the content (CPC) as well as return the name resolution result (block 552). The ECG may perform protocol translation and forward the legacy protocol requests to the legacy server (CRO) (block 553).

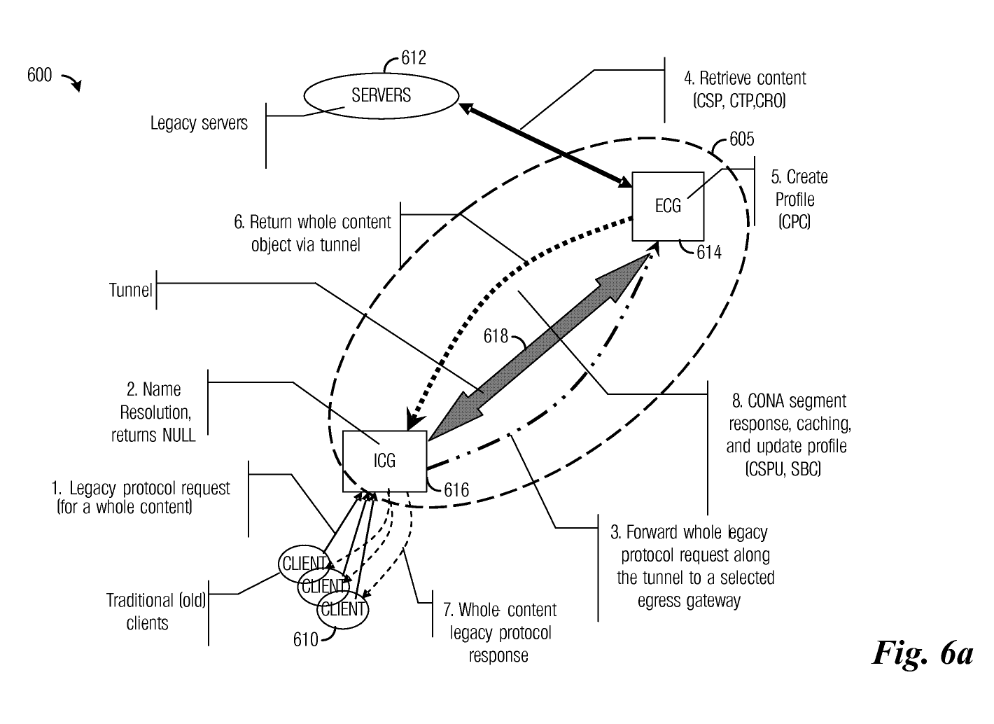

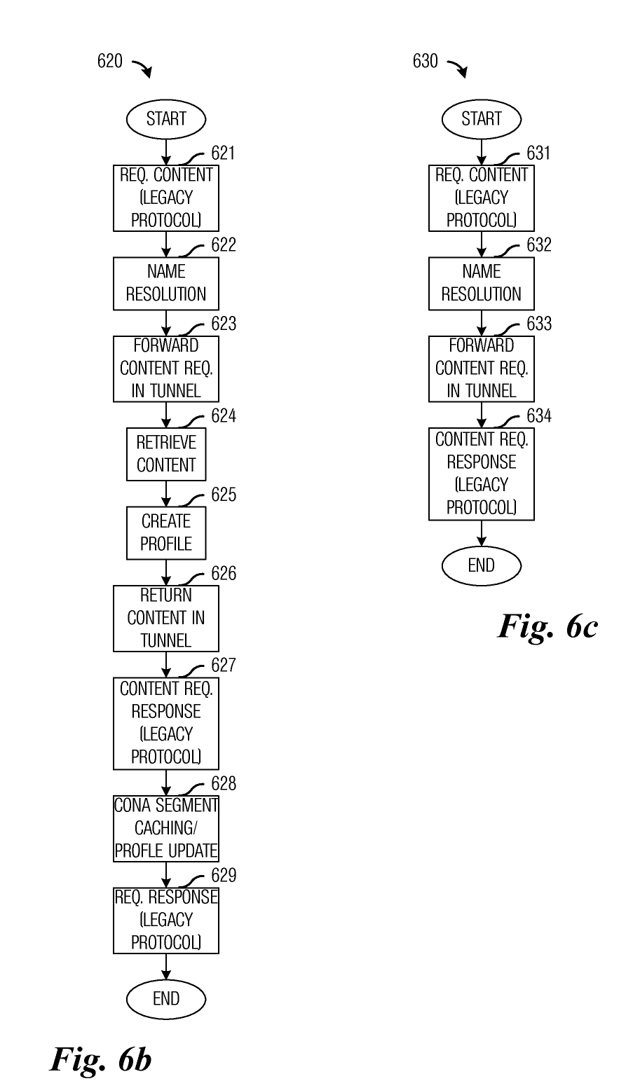

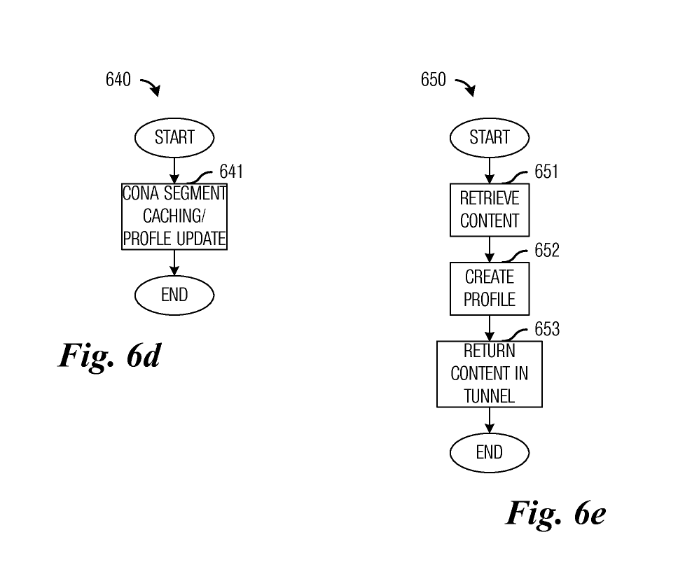

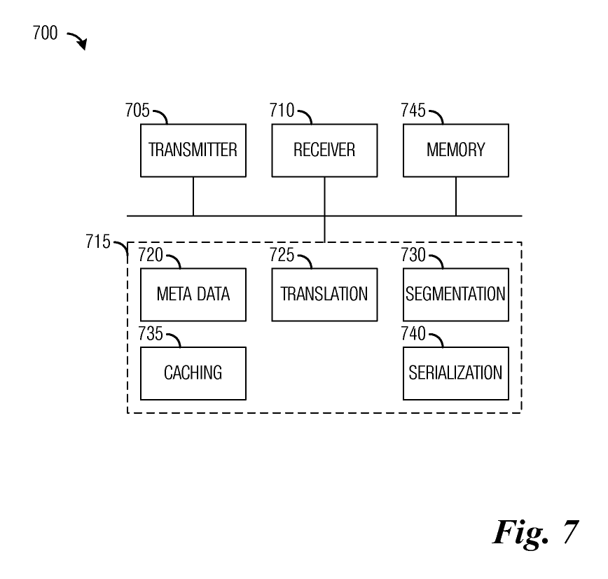

FIG. 6a illustrates a communications system 600 wherein a CONA network 605 interoperates with legacy clients 610 and legacy servers 612, wherein CONA network 605 includes an ICG 616 and an ECG 614 that are connected by a tunnel 618. As shown in FIG. 6a, if the content is new (no CONA meta data is available), then ICG 616 may forward as-is legacy protocol requests (i.e., content requests) to ECG 614 via tunnel 618. If the content is not new, ICG 616 may use existing CONA meta data for protocol translation, segmentation, and internal caching. Similarly, if the content is new, then ECG 614 may manage CSP, CTP, CPC, CRO, CSG, and segment caching, and may send requested content (i.e., content reply) to ICG 616 over tunnel 618. If the content is not new, then ECG 614 may manage CRS and CDS. CONA network 605 (or an entity in CONA network 605) may perform CONA internal caching (CSPU and SBC).

FIG. 6b illustrates a flow diagram of operations 620 occurring in a communications system that supports legacy clients and legacy servers but utilizes CONA protocols.

Operations 620 may begin with an ICG receiving a legacy protocol request for content from a legacy client, wherein the legacy protocol request may be a request for the content in its entirety (block 621). The ICG may perform name resolution for the whole content (block 622) and forward the legacy protocol request to an ECG over a tunnel (block 623). The ECG may retrieve the requested content from the legacy server (CSP, CTP, CRO) (block 624). The ECG may create a profile for the segments (CPC) (block 625). The ECG may return the entire contents over a tunnel (block 626). A CONA network entity may forward the CONA segment response in addition to segment caching (block 627) and profile updating (CSPU and SBC) (block 628). The ICG may provide the whole content to the legacy client (block 629).

FIG. 6c illustrates a flow diagram of operations 630 occurring in an ICG of a communications system that supports legacy clients and legacy servers but utilizes CONA protocols.

Operations 630 may begin with an ICG receiving a legacy protocol request for content from a legacy client, wherein the legacy protocol request may be a request for the content in its entirety (block 631). The ICG may perform name resolution for the whole content (block 632) and forward the legacy protocol request to an ECG over a tunnel (block 633). The ICG may provide the whole content to the legacy client (block 634).

FIG. 6d illustrates a flow diagram of operations 640 occurring in a network entity of a communications system that supports legacy clients and legacy servers but utilizes CONA protocols.

Operations 640 may begin with a CONA network entity forwarding the CONA segment response in addition to segment caching and profile updating (CSPU and SBC) (block 641).

FIG. 6e illustrates a flow diagram of operations 650 occurring in an ECG of a communications system that supports legacy clients and legacy servers but utilizes CONA protocols.

Operations 650 may begin with an ECG retrieving the requested content from the legacy server (CSP, CTP, CRO) (block 651). The ECG may create a profile for the segments (CPC) (block 652). The ECG may return the entire contents over a tunnel (block 653).

FIG. 7 illustrates a communications device 700. Communications device 700 may be used to implement various ones of the embodiments discussed herein. As an example, communications device 700 may be used to implement an ICG, an ECG, a subset of an ICG, a subset of an ECG, a subset of an ICG and ECG, or a combination thereof. As shown in FIG. 7, a transmitter 705 is configured to transmit information. A receiver 710 is configured to receive information. Transmitter 705 and receiver 710 may have a wireless interface, a wireline interface, or a combination thereof.

A meta data unit 720 is configured to generate meta data based on content requests. A translation unit 725 is configured to translate legacy protocols to CONA protocols or CONA protocols to legacy protocols. A segmentation unit 730 is configured to segment a content request into multiple content segment requests.

A caching unit 735 is configured to perform segment caching. Segment caching may involve caching of segments to memory, solid-state disks, hard disks, remote network storage, or a combination thereof. A serialization unit 740 is configured to assemble segmented responses to segment requests. A memory 745 is configured to store information, as well as storing content, requests, segment caching, and so forth. Memory 745 comprises solid-state memory, solid-state disks, hard disks, remote network storage, or a combination thereof.

The elements of communications device 700 may be implemented as specific hardware logic blocks. In an alternative, the elements of communications device 700 may be implemented as software executing in a processor, controller, application specific integrated circuit, or so on. In yet another alternative, the elements of communications device 700 may be implemented as a combination of software and/or hardware.

As an example, receiver 705 and transmitter 710 may be implemented as a specific hardware blocks, while meta data unit 720, translation unit 725, segmentation unit 730, caching unit 735, and serialization unit 740 may be software modules executing in a processor 715, microprocessor, a custom circuit, or a custom compiled logic array of a field programmable logic array.

Although the present invention and its advantages have been described in detail, it should be understood that various changes, substitutions and alterations can be made herein without departing from the spirit and scope of the invention as defined by the appended claims.

What is claimed is:

1. A content-oriented communications network comprising:
an ingress gateway in communication with a legacy client of a first legacy communications network, the ingress gateway configured to translate a content request of the legacy client from a first legacy protocol to a content-oriented protocol and to translate a content reply received in response to the content request from the content-oriented protocol to the first legacy protocol; and
an egress gateway in communication with the ingress gateway and a legacy server of a second legacy communications network, the egress gateway configured to translate the content request from the content-oriented protocol to a second legacy protocol and to translate the content reply received in response to the content request from the second legacy protocol to the content-oriented protocol.

2. The content-oriented communications network of claim 1, wherein the content-oriented protocol performs object naming, object locating, object routing, object delivery, object dissemination, object caching, object publishing, object subscription, accounting, billing, or a combination thereof.

3. The content-oriented communications network of claim 1, further comprising a content-oriented network entity coupled to the ingress gateway and to the egress gateway, the content-oriented network entity configured to store a segment of the content.

4. The content-oriented communications network of claim 3, wherein the ingress gateway and the content-oriented network entity are co-located in a single entity.

5. The content-oriented communications network of claim 3, wherein the egress gateway and the content-oriented network entity are co-located in a single entity.

6. The content-oriented communications network of claim 1, wherein the ingress gateway is configured to serialize the content request, and to serialize content in the content reply, and wherein the egress gateway is configured to retrieve the content according to the content request from the legacy server.

7. The content-oriented communications network of claim 1, wherein the ingress gateway is configured to probe for content size according to meta data in the content request, to probe for content type according to the meta data in the content request, and to segment and serialize content in the content reply, and wherein the egress gateway is configured to generate a content profile for the content in the content reply.

8. The content-oriented communications network of claim 1, wherein the egress gateway is configured to probe for content size according to meta data in the content request, to probe for content type according to the meta data in the content request, and to generate a content profile for content in the content reply.

9. The content-oriented communications network of claim 1, wherein the first legacy protocol or the second legacy protocol is a second content-oriented protocol that is a previous version of the content-oriented protocol.

10. The content-oriented communications network of claim 1, wherein the first legacy protocol or the second legacy protocol is an Internet Protocol protocol.

11. The content-oriented communications network of claim 1, wherein the ingress gateway and the egress gateway are co-located in a single entity.

12. A gateway comprising:
a receiver configured to receive a content request from a legacy client of a legacy communications network, the content request in a legacy protocol, and to receive a content reply in a content-oriented protocol, the content reply including content requested in the content request;
a processor coupled to the receiver, the processor configured to translate the content request from the legacy protocol to the content-oriented protocol, and to translate the content reply from the content-oriented protocol to the legacy protocol; and
a transmitter coupled to the processor, the transmitter configured to send the translated content request to a second gateway, and to send the translated content reply to the legacy client.

13. The gateway of claim 12, wherein the processor is configured to serialize the content in the content reply.

14. The gateway of claim 12, wherein the processor is configured to serialize the content request.

15. The gateway of claim 12, wherein the processor is configured to generate a content profile for the content in the content reply.

16. The gateway of claim 12, wherein the processor is configured to probe for content size according to meta data in the translated content request, to probe for content type according to the meta data in the translated content request, and to segment and serialize the content in the content reply.

17. A gateway comprising:
a receiver configured to receive a content request in a content-oriented protocol from a second gateway, and to receive a content reply in a legacy protocol, the content reply including content requested in the content request;
a processor coupled to the receiver, the processor configured to translate the content request from the content-oriented protocol to the legacy protocol, and to translate the content reply from the legacy protocol to the content-oriented protocol; and
a transmitter coupled to the processor, the transmitter configured to send the translated content request to a legacy server of a legacy communications system, and to send the translated content reply to the second gateway.

18. The gateway of claim 17, wherein the processor is configured to serialize the content request.

19. The gateway of claim 17, wherein the processor is configured to serialize the content.

20. The gateway of claim 17, wherein the processor is configured to generate a content profile from the translated content reply.

21. The gateway of claim 17, wherein the processor is configured to probe for content size according to meta data in the content request, to probe for content type according to the meta data in the content request, and generate a content profile for the profile in the translated content reply.

22. A method for operating an ingress gateway of a content-oriented communications network, the method comprising:
receiving a content request from a legacy client of a legacy communications network, the content request in a legacy protocol;
translating the content request from the legacy protocol to a content-oriented protocol;
sending the translated content request to an egress gateway of the content-oriented communications network;
receiving a content reply in the content-oriented protocol, the content reply including content requested in the content request;
translating the content reply from the content-oriented protocol to the legacy protocol; and
sending the translated content reply to the legacy client.

23. The method of claim 22, wherein translating the content request comprises serializing the content request.

24. The method of claim 22, wherein translating the content reply comprises serializing the content in the content reply.

25. The method of claim 22, further comprising generating a content profile for the content in the content reply.

26. The method of claim 22, further comprising
probing for content size according to meta data in the translated content request;
probing for content type according to the meta data in the translated content request; and
segmenting and serializing the content in the content reply.

27. A method for operating an egress gateway of a content-oriented communications network, the method comprising:
receiving a content request in a content-oriented protocol from an ingress gateway;
translating the content request from the content-oriented protocol to a legacy protocol;
sending the translated content request to a legacy server of a legacy communications network;
receiving a content reply in the legacy protocol, the content reply including content requested in the content request;
translating the content reply from the legacy protocol to the content-oriented protocol; and
sending the translated content reply to the ingress gateway.

28. The method of claim 27, wherein translating the content reply comprises serializing the content.

29. The method of claim 27, wherein translating the content request comprises serializing the content request.

30. The method of claim 27, further comprising generating a content profile for the content in the translated content reply.

31. The method of claim 27, further comprising:
probing for content size according to meta data in the content request;
probing for content type according to the meta data in the content request; and
generating a content profile for the profile in the translated content reply.
